(19) United States
(12) Patent Application Publication
(10) Pub. No.: US 2013/0007072 A1
(43) Pub. Date: Jan. 3, 2013

(54) CONTENT PLAYING/RECORDING APPARATUS, CONTENT PLAYING/RECORDING METHOD, AND PROGRAM

(75) Inventor: Yutaka Kobayashi, Tokyo (JP)

(73) Assignee: PANASONIC CORPORATION, Osaka (JP)

(21) Appl. No.: 13/583,914

(22) PCT Filed: Mar. 14, 2011
(86) PCT No.: PCT/JP2011/001454

§ 371 Date: Sep. 10, 2012

(30) Foreign Application Priority Data
Mar. 12, 2010 (JP) 2010-056128

(51) Int. Cl. G06F 17/30

(52) U.S. Cl. 707/812; 707/E17.01; 707/E17.009

(57) ABSTRACT

Provided is a playing/recording apparatus that has both a content playing function and a content recording function, even when the number of playing capability files that can be stored in an external memory is just one, and the number of playing capability information that can be written on the playing capability file is prescribed to be just one. The playing/recording apparatus can record content in accordance with the playing capability of other playing apparatuses. In the playing/recording apparatus (100), a retaining unit (103) reads the playing capability file stored in the inserted external memory, and retains the playing capability information of a playing apparatus other than the playing/recording apparatus (100), and a recording unit (102) records the content into the external memory on the basis of the playing capability information of the other playing apparatus.

### TECHNICAL FIELD

The present invention relates to a content playback/recording apparatus, a content playback/recording method and a program.

### BACKGROUND ART

In recent years, mobile terminal apparatuses use services of providing content such as video data via various media.

For example, a standard is being developed which relates to a service of transferring a content recorded in a content recording device that records a content (hereinafter simply referred to as “recording apparatus” such as BD (Bill-Ray Disc (registered trademark))/DVD recorder) to a content playing device that plays back the content (hereinafter simply referred to as “playback apparatus” such as mobile terminal apparatus) and using the content (e.g., see Non-Patent Literature 1).

According to this standard, the playback apparatus first reports playback capability information (also referred to as “recommended parameter level” or “class”) indicating a content playback capability of the playback apparatus (e.g., codec-related parameter, content characteristic, display resolution or processing capability) to the recording apparatus. The recording apparatus then converts/records the content based on the playback capability information of the playback apparatus (e.g., see Patent Literature 1 and Non-Patent Literature 1).

For example, a case will be described where playback capability information and a content are exchanged between the playback apparatus and the recording apparatus via an external storage medium such as a memory card (or removal media, hereinafter referred to as “external memory”), First, when the external memory is inserted, the playback apparatus writes the playback capability information of the playback apparatus to the external memory as a playback capability file (also referred to as “profiling file”, for example, file name: PF0804.PRF in Non-Patent Literature 1). Next, when the external memory (external memory storing the playback capability file) removed from the playback apparatus is inserted, the recording apparatus reads the playback capability file stored in the external memory (playback capability information of the playback apparatus). The storage apparatus converts the content according to the content characteristic based on the playback capability information of the playback apparatus and records the converted content in the external memory. In this way, the playback apparatus can play back the content recorded in the external memory by the recording apparatus, that is, content in accordance with the playback capability of the playback apparatus.

Furthermore, according to the standard disclosed in Non-Patent Literature 1, the number of the above-described playback capability files is prescribed to be one. Thus, only one playback capability file stored in the external memory is exchanged between the playback apparatus and the recording apparatus.

### CITATION LIST

### Patent Literature

PTL 1

Japanese Patent Application Laid-Open No. 2007-013602

### Non-Patent Literature

NPL 1

SD Specification Part 8 VIDEO Spec H.264 Mobile Video Profile Spec Ver1.00, Supplementary Notes Ver1.00

### SUMMARY OF INVENTION

### Technical Problem

In the future, a mobile terminal apparatus or the like may also operate as a content playback/recording apparatus having both a content playback function and a content recording function (hereinafter simply referred to as “playback/recording apparatus”). The playback/recording apparatus reports the playback capability information of the playback/recording apparatus to the recording apparatus (another device) as the playback apparatus and plays back the content recorded in the recording apparatus. On the other hand, the playback/recording apparatus records the content based on the playback capability information reported from the playback apparatus (the other device) as the recording apparatus.

For example, as described above, a case will be described where playback capability information and a content are exchanged between a playback/recording apparatus and a playback apparatus via an external memory. That is, as described above, when the external memory is inserted, the playback apparatus writes the playback capability information of the playback apparatus to the external memory as a playback capability file.

Next, when the external memory (external memory storing the playback capability file) removed from the playback apparatus is inserted in the playback/recording apparatus, the playback/recording apparatus, as the playback apparatus, writes the playback capability information of the playback/recording apparatus to the external memory as a playback capability file. Here, according to the standard disclosed in Non-Patent Literature 1, the number of the playback capability files is one as described above (that is, the number of pieces of playback capability information stored in the external memory is one). Therefore, in this case, the playback capability file stored in the external memory immediately before the insertion (playback capability information of the playback apparatus) is overwritten with the playback capability information of the playback/recording apparatus and the playback capability information of the playback apparatus is lost.

Therefore, even when the playback/recording apparatus reads the playback capability file stored in the external memory as the recording apparatus, it can obtain only playback capability information of the playback/recording apparatus, and cannot convert/record a content in accordance with the playback capability of the playback apparatus.

Thus, when an external memory storing playback capability information of the other playback apparatus as a playback capability file is inserted, the playback/recording apparatus having the content playback function and content recording function overwrites the playback capability file with the playback capability information of the playback/recording apparatus. For this reason, the playback capability information of the playback apparatus cannot be exchanged between the playback apparatus and the playback/recording apparatus that operates as the recording apparatus. That is, when the number of playback capability files stored in the external memory is prescribed to be one, the playback/recording apparatus cannot record the content in accordance with the playback capability of the other playback apparatus.

It is an object of the present invention to provide a content playback/recording apparatus that has a content playback function and a content recording function and can record a content in accordance with a playback capability of another playback apparatus even when the number of playback capability files stored in an external memory is one and the number of pieces of playback capability information that can be written in a playback capability file is prescribed to be one, a content playback/recording method and a program capable of achieving the same feature.

### Solution to Problem

A content playback/recording apparatus according to a first aspect of the present invention is a content playback/recording apparatus that can operate as a playback apparatus and a recording apparatus in a content transfer system in which when an external storage medium is inserted in the playback apparatus, playback capability information indicating a playback capability of a content in the playback apparatus is stored as a playback capability file in the external storage medium and the recording apparatus in which the external storage medium storing the playback capability file is inserted records the content in the external storage medium based on the playback capability information of the playback apparatus, and the number of pieces of the playback capability information that can be stored in the external storage medium is one, the content playback/recording apparatus adopting a configuration including a retaining section that reads the playback capability file stored in the inserted external storage medium and retains the playback capability information of a playback apparatus other than the content playback/recording apparatus and a recording section that records the content in the external storage medium based on the playback. capability information of the other playback apparatus.

A content playback/recording method according to a second aspect of the present invention is a content playback/recording method for a content playback/recording apparatus that can operate as a playback apparatus and a recording apparatus in a content transfer system in which when an external storage medium is inserted in the playback apparatus, playback capability information indicating a playback capability of a content in the playback apparatus is stored as a playback capability file in the external storage medium and the recording apparatus in which the external storage medium storing the playback capability file is inserted records the content in the external storage medium based on the playback capability information of the playback apparatus, and the number of pieces of the playback capability information that can be stored in the external storage medium is one, the content playback/recording method adopting a configuration including a retaining step of reading the playback capability file stored in the inserted external storage medium and retaining the playback capability information of a playback apparatus other than the content playback/recording apparatus and a recording step of recording the content in the external storage medium based on the playback capability information of the other playback apparatus.

A program according to a third aspect of the present invention is a program for a content playback/recording apparatus that can operate as a playback apparatus and a recording apparatus in a content transfer system in which when an external storage medium is inserted in the playback apparatus, playback capability information indicating a playback capability of a content in the playback apparatus is stored as a playback capability file in the external storage medium and the recording apparatus in which the external storage medium storing the playback capability file is inserted records the content in the external storage medium based on the playback capability information of the playback apparatus, and the number of pieces of the playback capability information that can be stored in the external storage medium is one, the program causing a computer to execute a retaining step of reading the playback capability file stored in the inserted external storage medium and retaining the playback capability information of a playback apparatus other than the content playback/recording apparatus and a recording step of recording the content in the external storage medium based on the playback capability information of the other playback apparatus.

### Advantageous Effects of Invention

According to the present invention, even when the number of playback capability files stored in an external memory is one and the number of pieces of playback capability information that can be written in the playback capability file is prescribed to be one, the playback/recording apparatus having a content playback function and a content recording function can record content in accordance with a playback capability of another playback apparatus.

### BRIEF DESCRIPTION OF DRAWINGS

FIG. 1 is a block diagram illustrating a configuration of a playback/recording apparatus, an external memory, a playback apparatus and a recording apparatus according to Embodiment 1 of the present invention;

FIG. 2 is a diagram illustrating a processing flow of the playback/recording apparatus according to Embodiment 1 of the present invention;

FIG. 3 is a block diagram illustrating a configuration of a playback/recording apparatus, an external memory and a playback apparatus according to Embodiment 2 of the present invention;

FIG. 4 is a diagram illustrating a processing flow of the playback/recording apparatus according to Embodiment 2 of the present invention;

FIG. 5 is a block diagram illustrating a configuration of a playback/recording apparatus, an external memory and a playback apparatus according to Embodiment 3 of the present invention; and

FIG. 6 is a diagram illustrating a processing flow of the playback/recording apparatus according to Embodiment 3 of the present invention.

### DESCRIPTION OF EMBODIMENTS

Hereinafter, embodiments of the present invention will be described in detail with reference to the accompanying drawings.

A content transfer system will be described below in which when an external memory is inserted in a playback apparatus, playback capability information (recommended parameter level or class) indicating a content playback capability (content characteristic that can be played back in the playback apparatus or the like) in the playback apparatus is stored in the external memory as a playback capability file (profiling file), and a recording apparatus in which the external memory storing the playback capability file is inserted records the content in the external memory based on the playback capability information of the playback apparatus. Furthermore, as described above, the number of playback capability files that can be stored in the external memory is one and the number of pieces of playback capability information that can be written in the playback capability file is one. That is, suppose the number of pieces of playback capability information that can be stored in the external memory is prescribed to be one.

### Embodiment 1

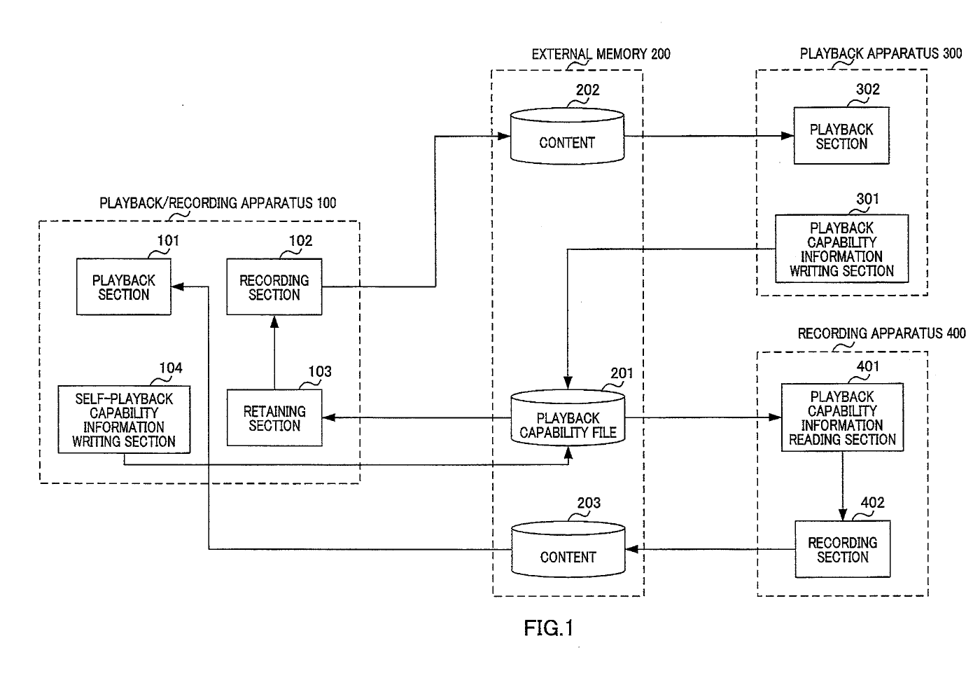

FIG. 1 is a block diagram illustrating a configuration of a playback/recording apparatus, an external memory, a playback apparatus and a recording apparatus according to the present embodiment.

Playback/recording apparatus 100, playback apparatus 300 and recording apparatus 400 shown in FIG. 1 are configured so that external memory 200 is attachable/detachable thereto/therefrom. Furthermore, playback/recording apparatus 100 shown in FIG. 1 can operate as a playback apparatus and a recording apparatus. That is, playback/recording apparatus 100 shown in FIG. 1 operates as a recording apparatus with respect to playback apparatus 300 and records a content based on playback capability information of playback apparatus 300. On the other hand, playback/recording apparatus 100 shown in FIG. 1 operates as a playback apparatus with respect to recording apparatus 400 and plays back a content recorded in recording apparatus 400 based on playback capability information of playback/recording apparatus 100.

In playback/recording apparatus 100 shown in FIG. 1, playback section 101 plays back content 203 stored in external memory 200 (in FIG. 1, the content recorded in recording apparatus 400 based on the playback capability information of playback/recording apparatus 100).

Recording section 102 records a content in external memory 200 through video recording, sound recording or the like. At this time, recording section 102 reads the playback capability information retained in retaining section 103 from retaining section 103 and records the content in external memory 200 based on the read playback capability information (in FIG. 1, playback capability information of playback apparatus 300, which is another device). That is, recording section 102 records content 202 converted to a content characteristic based on the playback capability information of playback apparatus 300 in external memory 200.

Retaining section 103 reads playback capability file 201 stored in inserted external memory 200 and retains playback capability information of playback apparatus 300, which is a playback apparatus other than playback/recording apparatus 100.

Self-playback capability information writing section 104 writes the playback capability information of playback/recording apparatus 100 (own apparatus) (information indicating a content characteristic or the like that can be played back in playback section 101) to external memory 200 as playback capability file 201. Here, the number of playback capability files that can be stored in external memory 200 is one. Therefore, when, for example, the playback capability information of playback apparatus 300 (another device) is stored in external memory 200 as playback capability file 201, self-playback capability information writing section 104 overwrites playback capability file 201 in external memory 200 with the playback capability information of playback/recording apparatus 100.

External memory 200 shown in FIG. 1 is an external storage medium (removal medium) that stores playback capability file 201 and content (in FIG. 1, content 202 and content 203) and is configured to be attachable/detachable (mountable/unmountable) to/from playback/recording apparatus 100, playback apparatus 300 and recording apparatus 400. However, the number of playback capability files stored in external memory 200 is prescribed to be one.

In playback apparatus 300 shown in FIG. 1, playback capability information writing section 301 writes the playback capability information of playback apparatus 300 (information indicating a content characteristic or the like that can be played back in playback section 302) to inserted external memory 200 as playback capability file 201. Playback section 302 plays back content 202 stored in external memory 200 (in FIG. 1, content recorded in playback/recording apparatus 100 (recording section 102) based on the playback capability information of playback apparatus 300).

In recording apparatus 400 shown in FIG. 1, playback capability information reading section 401 reads playback capability file 201 stored in inserted external memory 200 (in FIG. 1, playback capability information of playback/recording apparatus 100). Recording section 402 converts the content based on the playback capability information of playback/recording apparatus 100 read in playback capability information reading section 401 and records converted content 203 (content with a content characteristic based on the playback capability information of playback/recording apparatus 100) in external memory 200.

Next, details of processing of playback/recording apparatus 100 according to the present embodiment (e.g., mobile terminal apparatus) will be described.

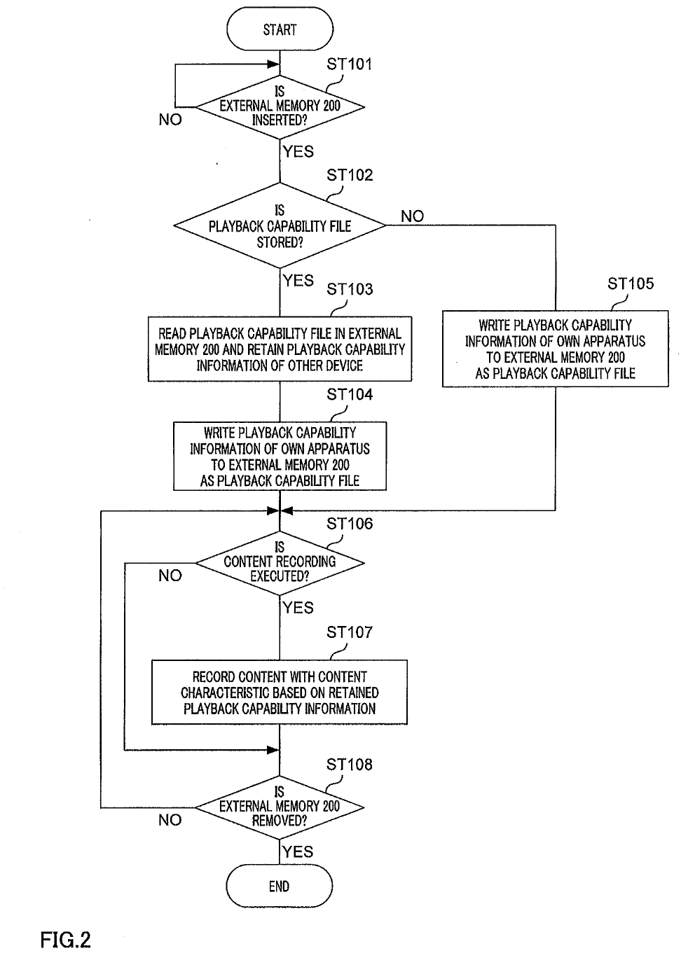

FIG. 2 is a diagram illustrating a content recording processing flow in playback/recording apparatus 100.

In FIG. 2, in step (hereinafter referred to as “ST”) 101, playback/recording apparatus 100 determines whether or not external memory 200 is inserted. When external memory 200 is not inserted in playback/recording apparatus 100 (ST101: NO), playback/recording apparatus 100 repeats the processing in ST101.

When external memory 200 is inserted in playback/recording apparatus 100 (ST101: YES), playback/recording apparatus 100 determines whether or not playback capability file 201 is stored in external memory 200.

When playback capability file 201 is stored in external memory 200 (ST102: YES), in ST103, retaining section 103 reads playback capability file 201 stored in external memory 200 (e.g., playback capability information of playback apparatus 300) and retains the playback capability information of playback apparatus 300, which is the other device.

In ST104, self-playback capability information writing section 104 writes the playback capability information of playback/recording apparatus 100 to external memory 200 as playback capability file 201. Here, playback capability file 201 is already stored in external memory 200 (ST102: YES). Thus, self-playback capability information writing section 104 overwrites playback capability file 201 in external memory 200 with the playback capability information of playback/recording apparatus 100.

On the other hand, when playback capability file 201 is not stored in external memory 200 (ST102: NO), in ST105, self-playback capability information writing section 104 writes the playback capability information of playback/recording apparatus 100 to external memory 200 as playback capability file 201.

In this way, when external memory 200 is inserted (ST101: YES), playback/recording apparatus 100 writes the playback capability information of playback/recording apparatus 100 to external memory 200 as playback capability file 201 (ST104 or ST105). However, when playback capability file 201 is already stored in external memory 200 (ST102: YES), playback/recording apparatus 100 first retains the playback capability information of playback apparatus 300, which is the other device, stored in external memory 200 in ST103. After retaining the playback capability information of playback apparatus 300, in ST104, playback/recording apparatus 100 overwrites playback capability file 201 in external memory 200 with the playback capability information of playback/recording apparatus 100.

In ST106, playback/recording apparatus 100 determines whether or not to record the content in external memory 200 using recording section 102. In other words, playback/recording apparatus 100 determines whether or not to operate as a recording apparatus. When playback/recording apparatus 100 determines that the content is recorded in external memory 200 using recording section 102 (ST106: YES), in ST107, recording section 102 records the content (in FIG. 1, content 202) with a content characteristic based on the playback capability information of playback apparatus 300 retained in retaining section 103 in ST103 in external memory 200. On the other hand, when playback/recording apparatus 100 determines that the content is not recorded in external memory 200 using recording section 102 (ST106: NO), playback/recording apparatus 100 performs nothing and moves to processing in ST108.

In ST108, playback/recording apparatus 100 determines whether or not external memory 200 is removed. When external memory 200 is removed (ST108: YES), playback/recording apparatus 100 ends the processing, and when external memory 200 is not removed (ST108: NO), playback/recording apparatus 100 returns to the processing in ST106.

For example, suppose playback/recording apparatus 100 performs content recording processing (ST106: YES), external memory 200 is removed from playback/recording apparatus 100 (after the processing shown in FIG. 2 ends), and external memory 200 is then inserted in playback apparatus 300 shown in FIG. 1. In this case, playback section 302 of playback apparatus 300 plays back content 202 in external memory 200. That is, in ST107, playback apparatus 300 plays back content 202 converted/recorded based on the playback capability information of playback apparatus 300 in recording section 102 of playback/recording apparatus 100.

On the other hand, suppose playback/recording apparatus 100 does not perform content recording processing (ST106: NO), external memory 200 is removed from playback/recording apparatus 100 (after the processing shown in FIG. 2 ends), and external memory 200 is then inserted in recording apparatus 400 shown in FIG. 1. In this case, playback capability information reading section 401 of recording apparatus 400 reads playback capability file 201 in external memory 200 and obtains playback capability information of playback/recording apparatus 100. Recording section 402 of recording apparatus 400 converts the content based on the playback capability information of playback/recording apparatus 100 and records the converted content in external memory 200 as content 203. Playback section 101 of playback/recording apparatus 100 then plays back content 203 stored in external memory 200 which is inserted again after its removal (content in accordance with the playback capability of playback/recording apparatus 100).

Thus, when external memory 200 storing the playback capability file (in FIG. 1, the playback capability information of playback apparatus 300) is inserted, playback/recording apparatus 100 reads the playback capability file stored in external memory 200 and retains the playback capability information of playback apparatus 300. Thus, playback/recording apparatus 100 can write (overwrite) the playback capability information of playback/recording apparatus 100 to playback capability file 201 in external memory 200 without losing the playback capability information of playback apparatus 300 (another playback apparatus).

That is, in the present embodiment, when the number of playback capability files is prescribed to be one, even when the external memory storing the playback capability information of playback apparatus 300 (another playback apparatus) as a playback capability file is inserted, playback/recording apparatus 100 can normally exchange the playback capability information of playback apparatus 300 (another playback apparatus) between playback apparatus 300 and playback/recording apparatus 100 operating as a recording apparatus. Similarly, playback/recording apparatus 100 can normally exchange the playback capability information of playback/recording apparatus 100 between recording apparatus 400 and playback/recording apparatus 100 operating as a playback apparatus.

Thus, when operating as the playback apparatus (ST106: NO shown in FIG. 2), playback/recording apparatus 100 stores the playback capability information of playback/recording apparatus 100 in external memory 200 as playback capability file 201, in this way, playback/recording apparatus 100 can acquire the content recorded in recording apparatus 400 based on the playback capability information of playback/recording apparatus 100 and play back the content. Furthermore, although playback/recording apparatus 100 overwrites the playback capability file in external memory 200 as described above, when operating as the recording apparatus, playback/recording apparatus 100 can record the content in external memory 200 based on the playback capability information of playback apparatus 300.

Thus, according to the present embodiment, even when the number of playback capability files stored in the external memory is one and the number of pieces of playback capability information that can be written in the playback capability file is prescribed to be one, the playback/recording apparatus having the playback function and the recording function can record a content in accordance with the playback capability of the other playback apparatus.

### Embodiment 2

The present embodiment is similar to Embodiment 1 in that the playback/recording apparatus reads a playback capability file stored in an inserted external memory (playback capability information of another playback apparatus) and retains the playback capability information of the other playback apparatus. In the present embodiment, when performing content recording processing (that is, when operating as a recording apparatus), the playback/recording apparatus further writes back retained playback capability information of the other playback apparatus to the external memory as playback capability file 201.

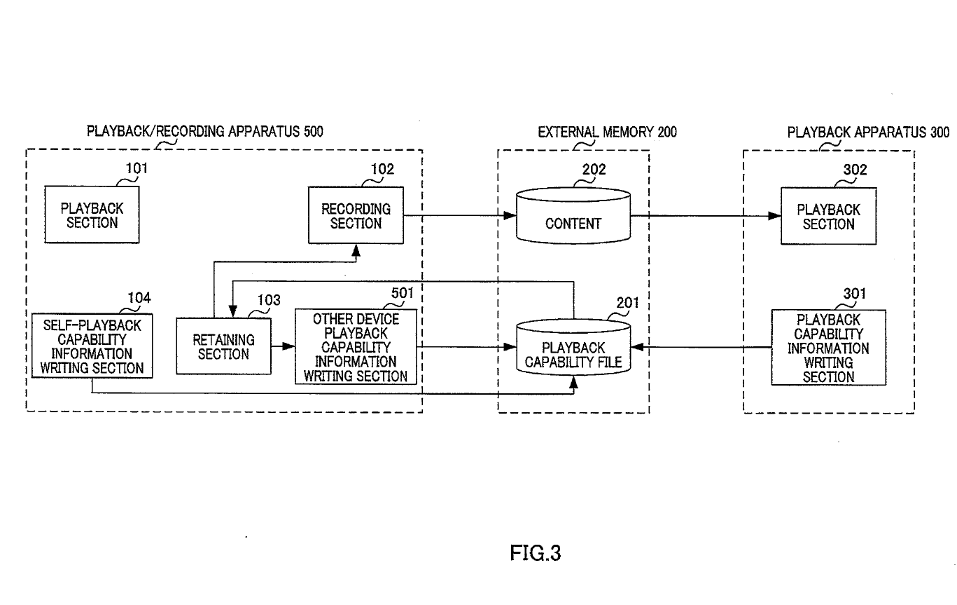

Hereinafter, the present embodiment will be described more specifically. FIG. 3 is a block diagram illustrating a configuration of a playback/recording apparatus, an external memory and a playback apparatus according to the present embodiment, In FIG. 3, components identical to those in Embodiment 1 (FIG. 1) will be assigned identical reference numerals and descriptions thereof will be omitted. Furthermore, to avoid the description from becoming complicated, in FIG. 3, the description of the processing that playback section 101 in playback/recording apparatus 500 plays back a content recorded in a recording apparatus (not shown), which is processing similar to that in Embodiment 1 (FIG. 1) will be omitted.

In playback/recording apparatus 500 shown in FIG. 3, other device playback capability information writing section 501 reads playback capability information of playback apparatus 300 which is the other playback apparatus retained in retaining section 103 (that is, playback capability information stored in external memory 200 at the time of insertion). When recording section 102 records a content in external memory 200, other device playback capability information writing section 501 writes back the playback capability information of playback apparatus 300, which is the other playback apparatus, read from retaining section 103 to external memory 200 as playback capability file 201.

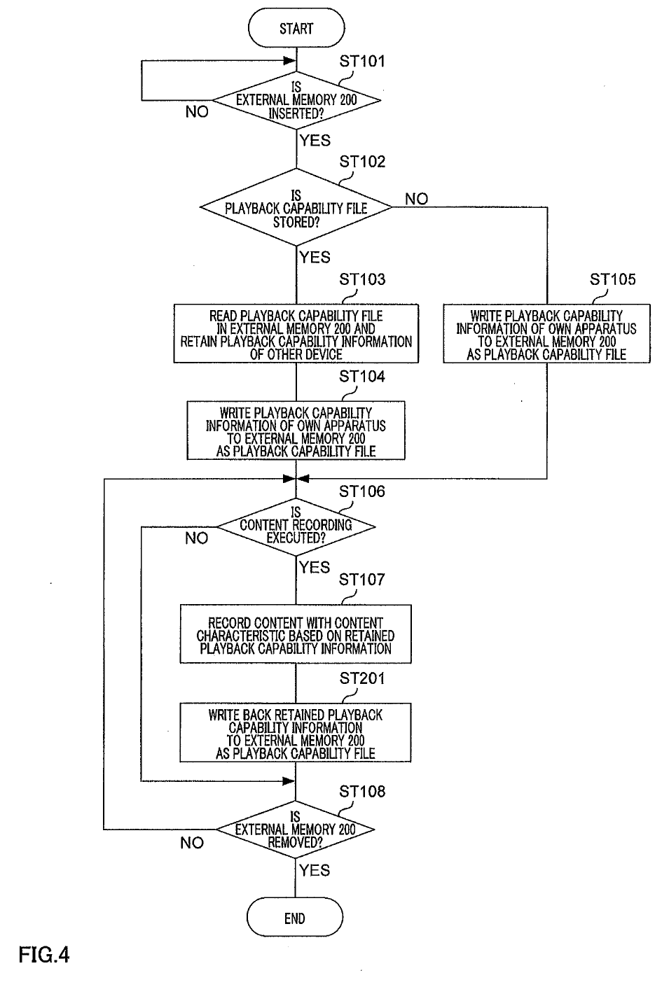

Next, details of the processing in playback/recording apparatus 500 according to the present embodiment will be described. FIG. 4 is a diagram illustrating a content recording processing flow of playback/recording apparatus 500. In FIG. 4, processes identical to those in Embodiment 1 (FIG. 2) will be assigned identical reference numerals and descriptions thereof will be omitted.

Here, suppose playback capability information of playback apparatus 300 is stored in external memory 200 shown in FIG. 3 as playback capability file 201. In this case, when external memory 200 storing playback capability file 201 is inserted (ST101: YES and ST102: YES) in playback/recording apparatus 500, retaining section 103 of playback/recording apparatus 500 retains playback capability file 201 stored in external memory 200 at the time of insertion, that is, the playback capability information of playback apparatus 300 as in the case of Embodiment 1 (ST103). Playback capability file 201 in external memory 200 is overwritten with the playback capability information of playback/recording apparatus 100 (ST104).

When playback/recording apparatus 500 determines that the content is recorded in external memory 200 through recording section 102 (ST106: YES), in ST201 shown in FIG. 4, other device playback capability information writing section 501 writes back the playback capability information of playback apparatus 300 read from retaining section 103 (playback capability information retained in retaining section 103 in ST103) to external memory 200 as playback capability file 201.

That is, when playback/recording apparatus 500 performs content recording processing (ST106: YES), the playback capability information of playback apparatus 300 (another playback apparatus) is stored in external memory 200 after removal (ST108: YES) as playback capability file 201. That is, the playback capability information stored in external memory 200 at the time of insertion in playback/recording apparatus 500 (playback capability information of playback apparatus 300) remains stored in playback capability file 201 in external memory 200 as is.

Thus, when recording section 102 performs content recording processing, that is, playback/recording apparatus 500 operates as a recording apparatus, playback/recording apparatus 500 writes back the playback capability information of playback apparatus 300 to playback capability file 201 in external memory 200. Thus, regarding external memory 200 inserted in playback/recording apparatus 500, even when it is removed from playback/recording apparatus 500, only content 202 shown in FIG. 3 is added and the contents of the stored playback capability file remains unchanged compared to the situation in external memory 200 at the time of insertion. That is, when playback/recording apparatus 500 operates as the recording apparatus, writing processing of the playback capability information of playback/recording apparatus 500 (ST104 or ST105 shown in FIG. 4) which is the operation as the playback apparatus of playback/recording apparatus 500 is not reflected in external memory 200 after its removal.

Therefore, even when, for example, a content to be played back in playback apparatus 300 is recorded in external memory 200 by a plurality of recording apparatuses (recording apparatuses other than playback/recording apparatus 500 or playback/recording apparatus 500), it is not necessary to insert external memory 200 in playback apparatus 300 again and write the playback capability information of playback apparatus 300 to external memory 200. That is, a plurality of recording apparatuses can record the content in external memory 200 in accordance with the playback capability of playback apparatus 300 only by sequentially inserting external memory 200 after its removal from playback/recording apparatus 500 in recording apparatuses (recording apparatuses other than playback/recording apparatus 500 or playback/recording apparatus 500).

Furthermore, when operating as the recording apparatus, playback/recording apparatus 500 retains playback capability information of playback apparatus 300 stored in external memory 200 at the time of insertion as in the ease of Embodiment 1. Therefore, even when the playback capability file in external memory 200 is overwritten with the playback capability information of playback/recording apparatus 500, playback/recording apparatus 500 can record the content in external memory 200 based on the playback capability information of playback apparatus 300 as in the case of Embodiment 1.

On the other hand, when playback/recording apparatus 500 does not perform content recording processing (ST106: NO), the playback capability information of playback/recording apparatus 500 is stored in external memory 200 after its removal (ST108: YES) as playback capability file 201. That is, when playback/recording apparatus 500 does not perform content recording processing, playback capability information (playback capability information of playback/recording apparatus 100) which is different from the playback capability information (playback capability information of playback apparatus 300) stored in external memory 200 at the time of insertion in playback/recording apparatus 500 is stored in playback capability file 201 in external memory 200 after its removal.

That is, when recording section 102 does not perform content recording processing, that is, when playback/recording apparatus 500 operates as the playback apparatus, playback/recording apparatus 500 stores the playback capability information of playback/recording apparatus 500 in external memory 200 as playback capability file 201 as in the case of Embodiment 1. This allows playback/recording apparatus 500 to acquire the content recorded based on the playback capability information of playback/recording apparatus 500 using a recording apparatus (not shown) and to play back the content.

Thus, according to the present embodiment, as in the case of Embodiment 1, even when the number of playback capability files stored in the external memory is one and the number of pieces of playback capability information that can be written in the playback capability file is prescribed to be one, the playback/recording apparatus having the playback function and the recording function can record a content in accordance with the playback capability of the other playback apparatus.

Furthermore, according to the present embodiment, when the playback/recording apparatus operates as a recording apparatus, the playback capability file in the external memory overwritten with the playback capability information of the playback/recording apparatus at the time of insertion is written back to the playback capability information of another playback apparatus (that is, the state at the time of insertion) again. That is, the contents of the playback capability file stored in the external memory are the same at the time of insertion and at the time of removal in/from the playback/recording apparatus (that is, the contents remain unchanged from the playback capability information of the other playback apparatus). Therefore, even when, for example, a plurality of recording apparatuses record a content played back by the same playback apparatus in an external memory, there is no need for the processing that the external memory is inserted into the playback apparatus after its insertion in the playback/recording apparatus (writing processing on the playback capability information of the playback apparatus). That is, only by sequentially inserting the external memory storing the playback capability information of the playback apparatus as a playback capability file in the recording apparatus (including the playback/recording apparatus), a plurality of recording apparatuses can record a content that is played back by one and the same playback apparatus. Therefore, the present embodiment can improve user convenience compared to Embodiment 1.

In the present embodiment, the processing order of the processing in ST107 shown in FIG. 4 (content recording processing by recording section 102) and the processing in ST201 (writing processing by other device playback capability information writing section 501) is not limited to the order shown in FIG. 4 (order of ST107, ST201), but may be a reverse order (order of ST201, ST107) or the processes may be performed simultaneously.

### Embodiment 3

The present embodiment will describe a case where when operating as a recording apparatus, the playback/recording apparatus selects whether to record a content based on playback capability information of the playback/recording apparatus or to record a content based on playback capability information of another playback apparatus stored in an external memory.

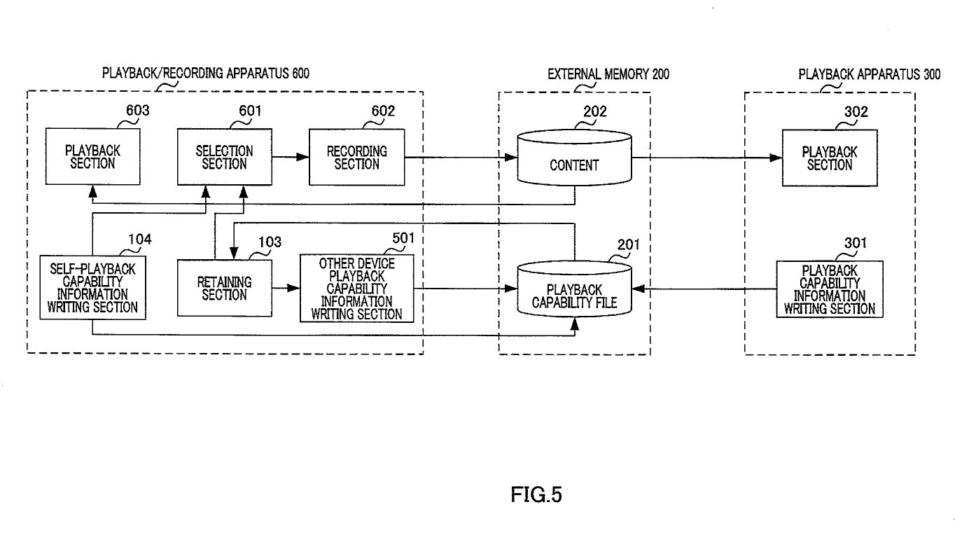

Hereinafter, the present embodiment will be described more specifically. FIG. 5 is a block diagram illustrating a configuration of a playback/recording apparatus, an external memory and a playback apparatus according to the present embodiment. In FIG. 5, components identical to those in Embodiment 2 (FIG. 3) will be assigned identical reference numerals and descriptions thereof will be omitted.

In playback/recording apparatus 600 shown in FIG. 5, selection section 601 receives playback capability information of playback/recording apparatus 600 from self-playback capability information writing section 104 as input. Furthermore, selection section 601 reads playback capability information of playback apparatus 300 (playback capability information stored in external memory 200 at the time of insertion) from retaining section 103. Selection section 601 selects one of the playback capability information of playback/recording apparatus 600 (own apparatus) and the playback capability information of playback apparatus 300 (another playback apparatus) through, for example, operation input from the user. Selection section 601 then outputs the selected playback capability information to recording section 602.

Recording section 602 converts a content based on the playback capability information inputted from selection section 601 (playback capability information of playback/recording apparatus 600 or playback capability information of playback apparatus 300) and records converted content 202 in external memory 200. To be more specific, when selection section 601 selects the playback capability information of playback apparatus 300 (another playback apparatus), recording section 602 records content 202 in external memory 200 based on the playback capability information of playback apparatus 300. On the other hand, when selection section. 601. selects the playback capability information of playback/recording apparatus 600, recording section 602 records content 202 in external memory 200 based on the playback capability information of playback/recording apparatus 600.

Playback section 603 plays back a content (not shown) recorded in a recording apparatus other than playback/recording apparatus 600 based on the playback capability information of playback/recording apparatus 600 or a content (content 202) recorded in recording section 602 (that is, playback/recording apparatus 600) based on the playback capability information of playback/recording apparatus 600.

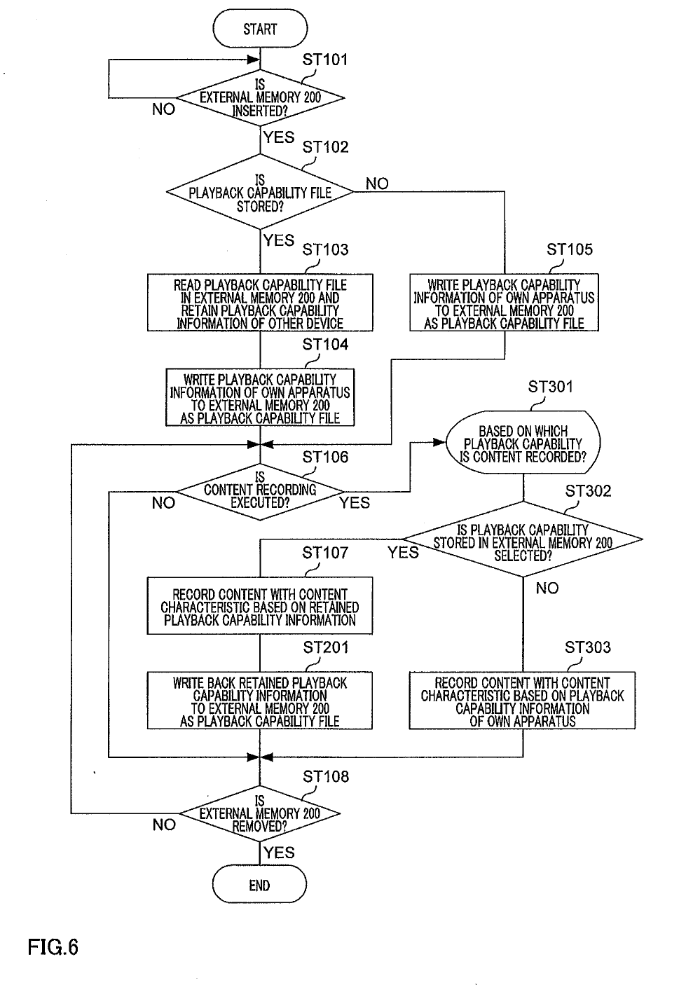

Next, details of processing in playback/recording apparatus 600 according to the present embodiment will be described. FIG. 6 is a diagram illustrating a content recording processing flow in playback/recording apparatus 600. In FIG. 6, processes identical to those in Embodiment 2 (FIG. 4) will be assigned identical reference numerals and descriptions thereof will be omitted.

In ST301 shown in FIG. 6, selection section 601 selects to record which of the two types of playback capability information; playback capability information of playback/recording apparatus 600 (own apparatus) and playback capability information of playback apparatus 300 (another playback apparatus). For example, selection section 601 displays a message to urge the user to select which of playback/recording apparatus 600 or playback apparatus 300 play backs the content (based on which of the two types of playback capability information the content should be recorded). Selection section 601 then selects one of the playback capability information of playback/recording apparatus 600 and the playback capability information of playback apparatus 300 through, for example, operation input from the user.

In ST302, recording section 602 determines which of the playback capability information of playback/recording apparatus 600 or the playback capability information of playback apparatus 300 is selected in ST301. When selection section 601 selects the playback capability information stored in external memory 200 at the time of insertion (playback capability information of playback apparatus 300) (ST302: YES), recording section 602 records the content with a content characteristic based on the playback capability information of playback apparatus 300 (playback capability information retained in retaining section 103) in external memory 200 in ST107 as in the case of Embodiment 1.

On the other hand, when selection section 601 does not select the playback capability information stored in external memory 200 at the time of insertion (ST302: NO), that is, when selection section 601 selects the playback capability information of playback/recording apparatus 600, in ST303, recording section 602 records the content with a content characteristic based on the playback capability information of playback/recording apparatus 600 (own apparatus) in external memory 200.

Thus, playback/recording apparatus 600 can determine whether the user intends that playback/recording apparatus 600 should play back the content or the user intends that other playback apparatus 300 should play back the content at the time of content recording processing. Thus, playback/recording apparatus 600 can record the content in external memory 200 with a content characteristic based on the playback capability of the playback apparatus whereby the user intends that the content should be played back.

Furthermore, when operating as the playback apparatus as in the case of Embodiment 1, playback/recording apparatus 600 stores the playback capability information of playback/recording apparatus 600 in external memory 200 as playback capability file 201. Thus, playback/recording apparatus 600 can acquire the content recorded based on the playback capability information of playback/recording apparatus 600 using a recording apparatus (not shown) and play back the content as in the case of Embodiment 1.

On the other hand, when operating as the recording apparatus that records a content for playback apparatus 300 (another playback apparatus) (when selection section 601 selects the playback capability information of playback apparatus 300), playback/recording apparatus 600 retains the playback capability information of playback apparatus 300 stored in external memory 200 at the time of insertion as in the case of Embodiment 1. For this reason, even when the playback capability file in external memory 200 is overwritten with the playback capability information of playback/recording apparatus 600, playback/recording apparatus 600 can record the content in external memory 200 based on the playback capability information of playback apparatus 300 as in the case of Embodiment 1.

Thus, according to the present embodiment, as in the case of Embodiment 1, even when the number of playback capability files stored in the external memory is one and the number of pieces of playback capability information that can be written in the playback capability file is prescribed to be one, the playback/recording apparatus having the playback function and the recording function can record a content in accordance with a playback capability of another playback apparatus.

Furthermore, according to the present embodiment, during content recording processing in the playback/recording apparatus, it is possible to select an apparatus that plays back the content (playback/recording apparatus or another playback apparatus) and improve user convenience compared to Embodiment 1.

Furthermore, according to the present embodiment, as in the case of Embodiment 2, when the playback/recording apparatus operates as the recording apparatus for the other playback apparatus (in FIG. 5, playback apparatus 300), the playback capability file in the external memory overwritten with the playback capability information of the playback/recording apparatus at the time of insertion is written back to the playback capability information of the other playback apparatus (that is, the state at the time of insertion) again. As in the case of Embodiment 2, this allows a plurality of recording apparatuses to record a content played back in one and the same playback apparatus only by sequentially inserting the external memory storing the playback capability information of the playback apparatus as a playback capability file in the recording apparatus (including the playback/recording apparatus). Thus, the present embodiment can further improve user convenience compared to Embodiment 1.

In the present embodiment, timing at which the playback/recording apparatus selects one of the playback capability information of the playback/recording apparatus and the playback capability information of the other playback apparatus is not limited to the timing of the processing in ST301 shown in FIG. 6 (that is, timing after determining whether or not to perform the content recording processing). For example, the timing at which the playback/recording apparatus selects one of the playback capability information of the playback/recording apparatus and the playback capability information of the other playback apparatus may be timing at which the external memory is inserted or timing set by the user.

The embodiments of the present invention have been described so far.

A case has been described in the above embodiments where the playback/recording apparatus and the playback apparatus or recording apparatus exchange playback capability information and a content via an external memory. However, the playback/recording apparatus and the playback apparatus or recording apparatus may exchange playback capability information and a content not only via an external memory but also using wired means (e.g., USB cable) or wireless means. When, for example, the wired means (USB cable) is used, connecting the playback/recording apparatus operating as a playback apparatus and the recording apparatus via a USB cable is equivalent to processing of removing the external memory from the playback/recording apparatus (e.g., ST108; YES shown in FIG. 2) and then inserting the external memory in the recording apparatus in the above embodiment.

Furthermore, a case has been described in the above embodiments where the playback/recording apparatus records a content in the external memory through video or sound recording or the like as the recording apparatus. However, the playback/recording apparatus may save a downloaded content in the external memory as a saving apparatus. That is, the present invention is also applicable to cases where the playback/recording apparatus described in the above embodiments operates as a playback apparatus and recording apparatus or saving apparatus.

Furthermore, a case has been described. in the above embodiments where the playback/recording apparatus converts a content in accordance with a content characteristic based on the playback capability information of the playback apparatus and records the converted content in the external memory. However, when recording a content in the external memory, the playback/recording apparatus is not limited to a case where the content is converted in accordance with playback capability information, but may select a content in accordance with the playback capability information of the playback apparatus from among contents stored with several content characteristics. Alternatively, when downloading a content from a server or the like, the playback/recording apparatus may download a content in accordance with the playback capability information of the playback apparatus.

The disclosure of Japanese Patent Application

No. 2010-0561.28, filed on Mar. 12, 2010, including the specification, drawings and abstract is incorporated herein by reference in. its entirety.

### INDUSTRIAL APPLICABILITY

The present invention is applicable to a mobile terminal or the like having a playback function, recording function or saving function.

### REFERENCE SIGNS LIST

100, 500, 600 Playback/recording apparatus
200 External memory
300 Playback apparatus
400 Recording apparatus
101, 302, 603 Playback section
102, 402, 602 Recording section
103 Retaining section
104 Self-playback capability information writing section
201 Playback capability file
202, 203 Content
301 Playback capability information writing section
401 Playback capability information reading section
501 Other device playback. capability information writing section
601 Selection section

1. A content playback/recording apparatus that can operate as a playback apparatus and a recording apparatus in a content transfer system in which when an external storage medium is inserted in the playback apparatus, playback capability information indicating a playback capability of a content in the playback apparatus is stored as a playback capability file in the external storage medium and the recording apparatus in which the external storage medium storing the playback capability file is inserted, records the content in the external storage medium based on the playback capability information of the playback apparatus, and the number of pieces of the playback capability information that can be stored in the external storage medium is one, the content playback/recording apparatus comprising:
a retaining section that reads the playback capability file stored in the inserted external storage medium and retains the playback capability information of a playback apparatus other than the content playback/recording apparatus;
a recording section that records a content in the external storage medium based on the playback capability information of the other playback apparatus; and
a writing section that writes back, when the recording section records the content in the external storage medium, the playback capability information of the other playback apparatus to the external storage medium as the playback capability file.

2. (canceled)

3. The content playback/recording apparatus according to claim 1, further comprising a selection section that selects one of the playback capability information of the content playback/recording apparatus and the playback capability information of the other playback apparatus, wherein:
the recording section records, when the selection section selects the playback capability information of the content playback/recording apparatus, a content in the external storage medium based on the playback capability information of the content playback/recording apparatus, and records, when the selection section selects the playback capability information of the other playback apparatus, a content in the external storage medium based on the playback capability information of the other playback apparatus.

4. A content playback/recording method for a content playback/recording apparatus that can operate as a playback apparatus and a recording apparatus in a content transfer system in which when an external storage medium is inserted in the playback apparatus, playback capability information indicating a playback capability of a content in the playback apparatus is stored as a playback capability file in the external storage medium and the recording apparatus in which the external storage medium storing the playback capability file is inserted, records the content in the external storage medium based on the playback capability information of the playback apparatus, and the number of pieces of the playback capability information that can be stored in the external storage medium is one, the content playback/recording method comprising:
a retaining step of reading the playback capability file stored in the inserted external storage medium and retaining the playback capability information of a playback apparatus other than the content playback/recording apparatus;
a recording step of recording the content in the external storage medium based on the playback capability information of the other playback apparatus; and
a writing step of writing back, when the content is recorded in the external storage medium in the recording step, the playback capability information of the other playback apparatus to the external storage medium as the playback capability file.

5. A program for a content playback/recording apparatus that can operate as a playback apparatus and a recording apparatus in a content transfer system in which when an external storage medium is inserted in the playback apparatus, playback capability information indicating a playback capability of a content in the playback apparatus is stored as a playback capability file in the external storage medium and the recording apparatus in which the external storage medium storing the playback capability file is inserted, records the content in the external storage medium based on the playback capability information of the playback apparatus, and the number of pieces of the playback capability information that can be stored in the external storage medium is one, the program causing a computer to execute:
a retaining step of reading the playback capability file stored in the inserted external storage medium and retaining the playback capability information of a playback apparatus other than the content playback/recording apparatus;
a recording step of recording a content in the external storage medium based on the playback capability information of the other playback apparatus; and
a writing step of writing back, when the content is recorded in the external storage medium in the recording step, the playback capability information of the other playback apparatus to the external storage medium as the playback capability file.
